(19) United States
(12) Patent Application Publication
(10) Pub. No.: US 2007/0128324 A1
(43) Pub. Date: Jun. 7, 2007

(54) Process for producing yoghurt with controlled texture and consistency

(76) Inventor: Edwin Lowe, Palmerston North (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/569,024

(22) PCT Filed: Aug. 19, 2004
(86) PCT No.: PCT/NZ04/00189

§ 371 Date: Sep. 7, 2006

(30) Foreign Application Priority Data
Aug. 19, 2003 (NZ) 527678

(51) Int. Cl. A23C 21/00

(52) U.S. Cl. 426/583

(57) ABSTRACT

The invention is a process for preparing a yoghurt with a desired gel strength. It is based on the unexpected observation that gel strength can be varied by varying the pH to an optimum at a given weight ratio of casein to whey protein. Whey protein is added to a milk and the casein:whey protein weight ratio is calculated. The optimum pH for that ratio is determined. The milk solution is then adjusted to that pH, heated to denature the whey protein and formed into yoghurt by known methods. The gel strength of the resulting yoghurt is determined by the optimum pH used in the heating step.

### TECHNICAL FIELD

The present invention relates to yoghurt production. More specifically, it relates to the use of whey protein in conjunction with the pH adjustment and heat treatment in yoghurt manufacture to control the consistency of yoghurt.

### BACKGROUND ART

Yoghurt-making processes have been developed over the years to improve the quality of the product delivered to consumers to ensure that yoghurt has a desirable texture and consistency.

To make yoghurt, milk is contacted with a lactic starter and then is fermented. Flavour develops over time and the intermediary “yoghurt milk” hardens to the desired gel-like texture, and is sold as yoghurt.

In modem yoghurt manufacture processes, the milk stream used undergoes a heat treatment. It is during this heating step that β-lactoglobulin is denatured, allowing it to bond to kappa-casein. Lucey & Singh (1998) suggested that the aggregation of denatured whey proteins with associated caseins at the isoelectric point of β-lactoglobulin is the beginning of the gelation process.

In U.S. Pat. No. 5,714,182 there is described a texturising product for use with yoghurt which is a co-precipitate of casein and whey protein. It is prepared by combining sweet whey protein with a milk based raw material at casein to whey protein weight ratios between 70:30 and 40:60 in a mixture having a pH within the range of 6.1 to 6.7. It is heated to obtain the co-precipitate and subjected to shear to obtain the texturising product. This was then combined with a milk for preparing a dairy product such as yoghurt. No mention was made of being able to optimize the gel strength of the resulting yoghurt through heat treatment at pH varied according to the ratio of whey protein to casein.

On a commercial scale it is difficult to control the texture and consistency of the final product during the yoghurt-making process itself.

It is therefore an object of the invention to some way towards overcoming this disadvantage or at least to offer the public a useful choice.

### SUMMARY OF THE INVENTION

In one embodiment the invention is a process for preparing a yoghurt comprising the following steps:
a) adding a measured amount of whey protein to a milk and calculating the casein: whey protein weight ratio of the resultant mixture,
b) determining the optimum pH of the milk at the casein:whey protein ratio calculated in step a) for preparing a yoghurt having a desired gel strength,
c) adjusting the pH of the milk from step a) to the optimum pH determined in step b),
d) heating the milk from step c) to a temperature of 70° C. to its boiling point for a time of 0.1 seconds to 60 minutes, and
e) acidifying the milk from step d) using a microorganism treatment or chemical acidification to prepare a yoghurt.

In one embodiment the casein: whey protein weight ratio calculated in step a) is from 3.2:1 to 1.6:1, and the optimum pH determined in step b) is from 7.1 to 6.5.

In another embodiment the casein: whey protein weight ratio calculated in step a) is from 2.9:1 to 1.6:1 and the optimum pH determined in step b) is from 6.5 to 6.4.

In another embodiment the temperature in step d) is maintained for from 10 seconds to 30 minutes.

In one embodiment in step c) the pH is adjusted by the addition of either a food grade acid or base.

In another embodiment, prior to step e), the pH of the milk is adjusted to 6.7, when required.

In another embodiment step e) is conducted at a temperature at or below about 30° C.

In another embodiment in step d) glucono-delta-lactone is hydrolysed to acidify the milk.

In a still further embodiment the invention is a yoghurt prepared by the process defined above.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### BRIEF DESCRIPTION OF THE DRAWINGS

FIG. 1 is a graph showing the effect of different pH levels during heat treatment on the final acid gel strength for reconstituted skim milk with no added whey protein.

FIG. 2 is a graph comparing the effect of different pH levels during heat treatment on the final acid gel strength where two different starters were used: Whey protein (added as whey protein concentrate with 80% protein) fortified reconstituted skim milk and non-fortified reconstituted skim milk.

FIG. 3 is a graph showing the effect of heat treatment, pH and different levels of whey protein fortification on the final acid gel strength.

FIG. 4 is a plot of resultant gel strength against pH for measured additions of whey protein to a 10% W/W solids reconstituted skim milk as described in example 3.

FIG. 5 is a plot of the same variables using a 15% W/W solids reconstituted skim milk as described in example 4.

FIG. 6 is a graph showing the optimum heat treatment pH at varying weight ratios of casein: whey protein with a 10% and 15% solids reconstituted skim milk.

### DETAILED DESCRIPTION OF THE INVENTION

References to “yoghurt texture” include references to the texture of any intermediary gel produced during the yoghurt making process (e.g. acid gel strength).

A “milk” refers to any source of milk which can be used to make yoghurt. In the embodiments described in the examples of this specification, the milk is reconstituted skim milk. However, other milk sources such as whole milk or skim milk may be used.

The expression “optimum pH” means the pH for a measured casein: whey protein weight ratio in a milk to which whey protein has been added which results in a yoghurt having a desired gel strength after carrying out the process of the invention. The desired gel strength will usually be the highest, but other gel strengths may be selected.

Whey proteins are often added to yoghurt to improve its texture, water holding ability and mouthfeel. It is thought that the effect of whey protein on yoghurt texture is related to the heat denaturation of the whey proteins, particularly β-lactoglobulin, in the presence of casein micelles.

The applicant has discovered that if whey protein fortified milk is heated at a pH below or above its natural pH, then the texture of the resulting yoghurt is altered.

Where the whey protein fortification level is relatively high, the applicant has discovered that heating the milk at a pH lower than the natural pH of the milk results in a firmer yoghurt texture.

Where the whey protein fortification level is relatively low, the applicant has discovered that heating the milk at a pH above the natural pH of the milk results in a firmer yoghurt texture as the pH increases.

Furthermore, the applicant has discovered that for any given level of whey protein to milk, there is an optimum pH for heat treatment which results in the firmest yoghurt texture.

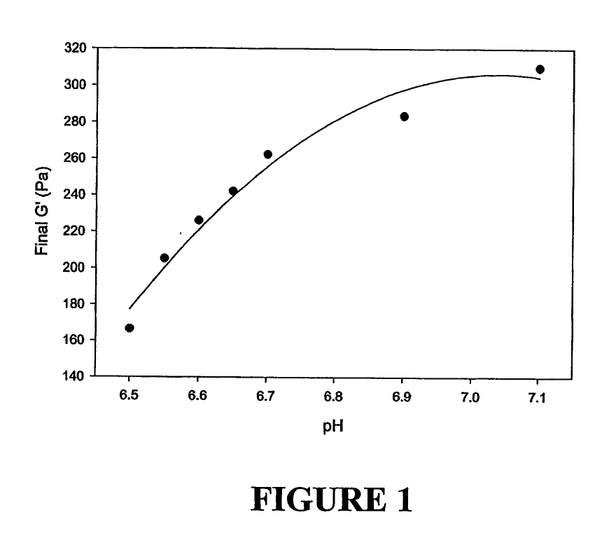

FIG. 1 shows that as the heat treatment pH of a non-fortified milk is increased, the texture of the final acid gel strength increases, but tapers off after the heat treatment pH reaches approximately 7.0.

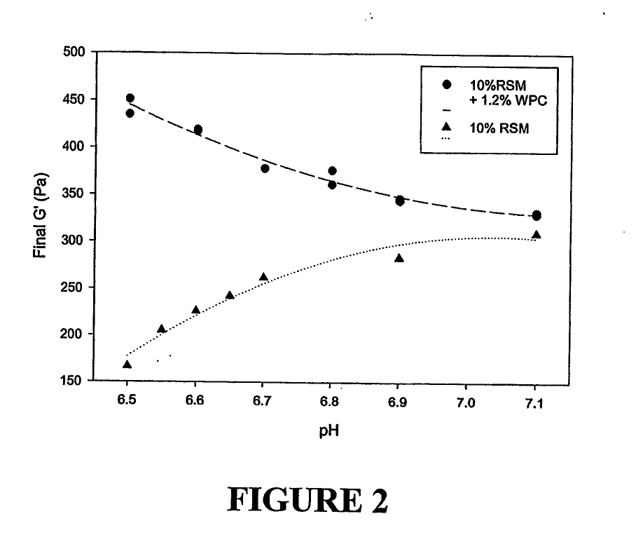

FIG. 2 shows that the whey protein fortified starter (in this example 10% reconstituted skim milk with 1.2% added 80% whey protein concentrate) results in increased acid gel strength with lower heat treatment pH. This is in stark contrast with the non-fortified milk example shown in both FIGS. 1 and 2.

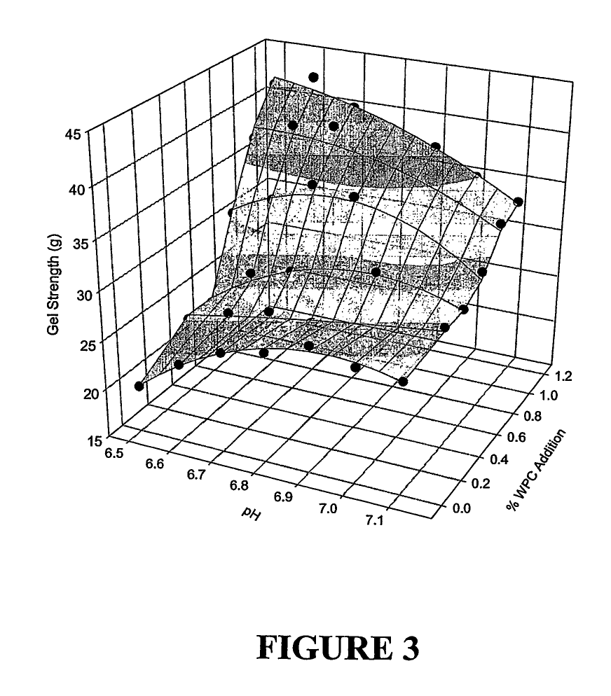

FIG. 3 shows that the whey protein concentration also affects the resulting acid gel strength. In this particular example, where the whey protein concentration was under 0.32%, higher heat treatment pH levels resulted in higher acid gel strength. Where the whey protein concentration was above 0.32%, lower heat treatment pH levels resulted in higher acid gel strength.

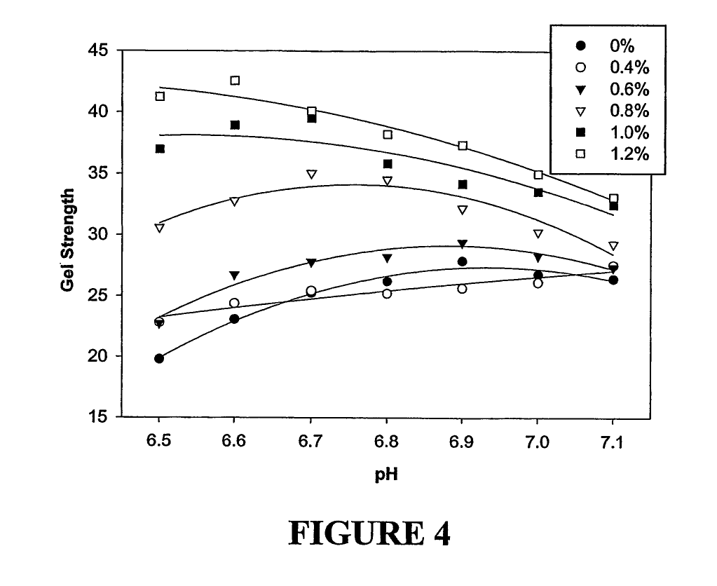

FIG. 4 demonstrates that for any given whey protein fortified milk, the concentration of whey protein in the starter will affect what the optimal heat strength pH is (in order to give the highest acid gel strength).

As used herein, “WPC80” refers to a whey protein concentrate containing about 80% protein.

### EXAMPLES

### Example 1

Acid Gels Prepared from Reconstituted Skim Milk.

TABLE 1
Reconstituted Skim Milk (RSM)

| | Weight (g) |
|---|---|
| Low heat skim milk powder | 100 g |
| Water | 900 g |

Milk Preparation, pH Adjustment and Heating

Reconstituted skim milk samples were prepared by adding low heat skim milk powder (100 g, whey protein nitrogen index above 6; 37% protein, Fonterra Co-operative Group, Pahiatua Manufacturing Site, New Zealand) to purified water (900 g, purified by reverse osmosis followed by filtration through Milli-Q™ apparatus) to a final concentration of 10% (w/w) total solids. The casein to whey ratio was 4:1 in the sample. The reconstituted skim milk samples were allowed to equilibrate at ambient temperature (about 20° C.) for at least 10 h before further treatment.

The skim milk was separated into several sub-samples. The pH of the milk of each of the sub-samples was adjusted to be the range 6.5 to 7.1 with either 3M HCl or 3M NaOH. The samples were allowed to equilibrate for at least 2 h and then minor re-adjustments were made. The pH-adjusted milk samples (50 g) were placed in screw top glass bottles and heated at 80° C. for 30 minutes in a water bath. After heat treatment, the milk samples were cooled by immersion in cold running water until the temperature was below 30° C. The samples were stored for 6 h

at ambient temperature after heat treatment and before any further analysis.

Readjustment of the pH, Acidification and Rheological (Gel Strength) Measurements

The heated milk samples were carefully re-adjusted to the natural pH (pH 6.7) with 3 M HCl or 3 M NaOH. They were acidified by the hydrolysis of glucono-δ-lactone (GDL Sigma Chemical Co., St Louis, Mo., USA) at a 2% (w/w) level (9.8 g milk and 0.2 g GDL) and at 30° C.

The pH change with time was monitored using a combination glass electrode type InLab 422™ (Mettler Toledo™, Urdorf, Switzerland) and standard pH meter. The pH gradually changed from pH 6.7 at the start to pH 4.2 after 6 h.

The rheological changes during acidification were monitored with time using low amplitude dynamic oscillation on a standard controlled stress rheometer (e.g a PAAR PHYSICA™ US 200 rheometer with the Z3 DIN (25 mm) cup and bob arrangement (PHYSICA™ Messtechnik,GmbH, Stuttgart, Germany) or a Bohlin CVO™ rheometer and the C25 cup and bob arrangement (Bohlin Instruments UK, Cirencester, Gloucestershire, England)). A typical method has been described in Bikker et al (2000). A description of the storage modulus and other measured values (such as loss modulus, phase angle) are detailed in Ferry (1980). After addition of the GDL to the milk and stirring, the appropriate quantity of milk was transferred to the rheometer and the rheological measurements were started. The strain applied was 0.01. The samples were oscillated at a frequency of 0.1 Hz and the temperature of the sample was maintained at 30° C. Measurements were taken every 5 min for 6 h. The final gel strength was defined as the storage modulus (G′) after 6 h of acidification. After 6 h the pH of the samples was 4.2.

Gel Strength of the Acid Gel Samples

The samples heated at pH 6.5 had a gel strength (storage modulus) of 166.4 Pa.

The samples heated at pH 6.55 had a gel strength (storage modulus) of 205.1 Pa.

The samples heated at pH 6.6 had a gel strength (storage modulus) of 225.9 Pa.

The samples heated at pH 6.65 had a gel strength (storage modulus) of 241.9 Pa.

The samples heated at pH 6.7 had a gel strength (storage modulus) of 262.2 Pa.

The samples heated at pH 6.9 had a gel strength (storage modulus) of 283.5 Pa.

The samples heated at pH 7.1 had a gel strength (storage modulus) of 309.73 Pa.

These acid gel strength results are summarised in FIG. 1. This shows that the gel strengths of the acid gels can be varied depending on the pH at heating.

### Example 2

Acid Gels Prepared from Reconstituted Skim Milk with Added Whey Protein

TABLE 2
RSM with Whey Protein

| | Weight (g) |
|---|---|
| Low heat skim milk powder | 100 g |
| Whey Protein Concentrate (WPC 80) | 12 g |
| Water | 900 g |

Milk Preparation, pH Adjustment and Heating

Reconstituted skim milk samples were prepared by adding low heat skim milk powder (100 g, whey protein nitrogen index above 6; 37% protein, Fonterra Co-operative Group, New Zealand) to purified water (900 g, purified by reverse osmosis followed by filtration through Milli-Q apparatus) to a final concentration of 10% (w/w) total solids. Whey protein concentrate (12 g, ALACEN™ 132, Fonterra Co-operative Group, New Zealand) was added to the milk. The whey protein concentrate level (1.2%) for WPC80 is equivalent to the addition of 1.0% whey protein (W/W). This resulted in a casein to whey protein ratio of 1.6:1. The whey fortified reconstituted skim milk samples were allowed to equilibrate at ambient temperature (about 20° C.) for at least 10 h before further treatment.

The pH adjustment, heat treatments, acidification and Theological methodology were the same as described in Example 1.

Gel Strength of the Acid Gel Samples from Milk Samples Fortified with 1.2% WPC80

The samples heated at pH 6.5 had a gel strength (storage modulus) between 435 to 451 Pa.

The samples heated at pH 6.6 had a gel strength (storage modulus) between 417 to 419 Pa.

The samples heated at pH 6.7 had a gel strength (storage modulus) of 378 Pa.

The samples heated at pH 6.8 had a gel strength (storage modulus) between 361 to 376 Pa.

The samples heated at pH 6.9 had a gel strength (storage modulus) between 344 to 346 Pa.

The samples heated at pH 7.1 had a gel strength (storage modulus) between 330 to 332 Pa.

These acid gel strength results are summarised in FIG. 2, with a comparison with the results from Example 1. This shows that the gel strengths of the acid gels can be varied depending on the pH during heating.

### Example 3

Acid Gels Prepared from Reconstituted Skim Milk with Different Levels of Added Whey Protein.

TABLE 3
RSM with Whey Protein (Variable Concentrations)

| | Weight (g) |
|---|---|
| Low heat skim milk powder | 100 g |
| Whey Protein Concentrate (WPC80) | 0 to 12 g |
| Water | 900 g |

Milk Preparation, pH Adjustment and Heating

Reconstituted skim milk samples were prepared by adding low heat skim milk powder (100 g, whey protein nitrogen index above 6; 37% protein, Fonterra Co-operative Group, New Zealand) to purified water (900 g, purified by reverse osmosis followed by filtration through Milli-Q™ apparatus) at 50° C. to a final concentration of 10% (w/w) total solids. Whey protein concentrate (0 to 12 g, ALACEN™ 132, Fonterra Co-operative Group, New Zealand) was added to the milk. The whey fortified reconstituted skim milk samples were allowed to equilibrate at 50° C. for at least one hour before further treatment.

After reconstitution, the sample was split into equal portions and pH adjusted using either 1 M NaOH or 1 M HCl to values in the pH range 6.5 to 7.1. After holding overnight at 4° C., the samples were held at 30° C. for 30 min and the pH was readjusted. Heat treatment (80° C. for 30 min) was conducted in an 80° C. shaking waterbath. The sample (150 mL in 500 mL Schott bottles) were placed in the waterbath, and continuously shaken. After 30 min, the bottles were removed from the waterbath and placed in ice/water slurry. The sample was held at 30° C. for 4.5 h. The pH of the samples was then adjusted to 6.7 using 1 M NaOH or 1 M HCl. Table 4 summarises the samples that were prepared.

Heated milk (39.2 g) and GDL (0.8 g) were added together, stirred for 1 minute, poured into 50 mL plastic containers, and stored at 30° C. for 18 h. Each sample was prepared in triplicate.

After the gels were formed, the samples were analysed using a Universal TA-XT2™ texture analyser with a real time graphics and data acquisition software package (Stable Microsystems, Haselmare, England) to measure the gel strength. A 10-mm diameter probe was pushed into the acid gel samples (20° C.) at a constant rate (1 mm/s) for a set distance (20 mm), and then withdrawn at the same rate. The response was measured as force versus time. The initial force required to penetrate the product, the breaking force and the positive area under the force/time curve were measured. The breaking force was a measure of the acid gel strength.

TABLE 4
Composition and pH of samples for preparation of acid gels

| | | | Casein:Whey | |
|---|---|---|---|---|
| Sample ID | % RSM | % WPC80 | Protein Ratio | pH |
| 0.0% WPC80 | 10 | 0 | 4:1 | 6.5, 6.6, 6.7, 6.8, |
| Addition | | | | 6.9, 7.0, 7.1 |
| 0.2% WPC80 | 10 | 0.2 | 3.2:1 | 6.5, 6.6, 6.7, 6.8, |
| Addition | | | | 6.9, 7.0, 7.1 |
| 0.4% WPC80 | 10 | 0.4 | 2.7:1 | 6.5, 6.6, 6.7, 6.8, |
| Addition | | | | 6.9, 7.0, 7.1 |
| 0.6% WPC80 | 10 | 0.6 | 2.3:1 | 6.5, 6.6, 6.7, 6.8, |
| Addition | | | | 6.9, 7.0, 7.1 |
| 0.8% WPC80 | 10 | 0.8 | 2:1 | 6.5, 6.6, 6.7, 6.8, |
| Addition | | | | 6.9, 7.0, 7.1 |
| 1.0% WPC80 | 10 | 1.0 | 1.8:1 | 6.5, 6.6, 6.7, 6.8, |
| Addition | | | | 6.9, 7.0, 7.1 |
| 1.2% WPC80 | 10 | 1.2 | 1.6:1 | 6.5, 6.6, 6.7, 6.8, |
| Addition | | | | 6.9, 7.0, 7.1 |

Gel Strength of the Acid Gel Samples from Milk Samples Fortified with 0 to 1.2% WPC80

There is an interaction between heat treatment pH and WPC80 addition. At low levels of WPC80 addition (<0.4% WPC80; equivalent to a casein: whey protein ratio of 72.7), higher heat treatment pHs give the highest acid gel strength. However, at WPC80 addition levels above 0.4% (casein: whey protein ratio below about 2.7), this effect reverses, with increasingly lower pH giving higher acid gel strength. FIG. 3 summarises the effect of heat treatment pH and WPC80 addition on the final acid gel strength.

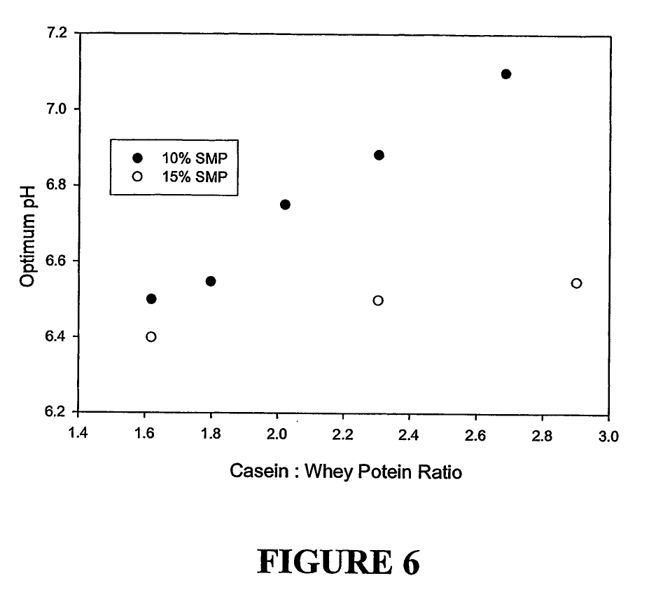

The way in which the maximum gel strength for a measured level of whey protein addition is determined is shown in FIG. 4. The pHs coinciding with the maximum gel strengths are then plotted against casein: whey protein weight ratios in FIG. 6.

### Example 4

Acid Gels Prepared from 15% Reconstituted Skim Milk with Different Levels of Added Whey Protein.

TABLE 5
RSM with Whey Protein (Variable Concentrations)

| | Weight (g) |
|---|---|
| Low heat skim milk powder | 150 g |
| Whey Protein Concentrate (WPC80) | 0 to 18 g |
| Water | 850 g |

Milk Preparation, pH Adjustment and Heating

Reconstituted skim milk samples were prepared by adding low heat skim milk powder (100 g, whey protein nitrogen index above 6; 37% protein, Fonterra Co-operative Group, New Zealand) to purified water (90 g, purified by reverse osmosis followed by filtration through Milli-Q™ apparatus) at 50° C. to a final concentration of 15% (w/w) total solids. Whey protein concentrate (0 to 18 g, ALACEN™ 131, Fonterra Co-operative Group, New Zealand) was added to the milk. The whey fortified reconstituted skim milk samples were allowed to equilibrate at 50° C. for at least one hour before further treatment.

After reconstitution, the sample was split into equal portions and pH adjusted using either 6 M NaOH or 6 M HCl to values in the pH range 6.3 to 6.7. After holding overnight at 4° C. Heat treatment (90° C. for 15 min) was conducted in an 90° C. waterbath. The sample (200 g in 250 mL Schott bottles) were placed in the waterbath. After 15 min, the bottles were removed from the waterbath and placed in ice/water slurry. The sample was held at 30° C. for 4.5 h. The pH of the samples was then adjusted to 6.7 using 1 M NaOH or 1 M HCl. Table 6 summarises the samples that were prepared.

Heated milk (39.2 g) and GDL (0.8 g) were added together, stirred for 1 minute, poured into 50 mL plastic containers, and stored at 30° C. for 18 h. Each sample was prepared in quadruplicate.

After the gels were formed, the samples were analysed using a Universal TA-XT2™ texture analyser with a real time graphics and data acquisition software package (Stable Microsystems, Haselmare, England) to measure the gel strength. A 10-mm diameter probe was pushed into the acid gel samples (20° C.) at a constant rate (1 mm/s) for a set distance (20 mm), and then withdrawn at the same rate. The response was measured as force versus time. The initial force required to penetrate the product, the breaking force and the positive area under the force/time curve were measured. The area was used as a measure of the acid gel strength.

TABLE 6
Composition and pH of samples for preparation of acid gels

| | | | Casein:Whey | |
|---|---|---|---|---|
| Sample ID | % RSM | % WPC80 | Protein Ratio | pH |
| 0.0% WPC80 | 15 | 0 | 4:1 | 6.30, 6.40, 6.51, |
| Addition | | | | 6.63, 6.76 |
| 0.45% WPC80 | 15 | 0.45 | 2.9:1 | 6.24, 6.37, 6.49, |
| Addition | | | | 6.61, 6.74 |
| 0.9% WPC80 | 15 | 0.9 | 2.3:1 | 6.26, 6.37, 6.79, |
| Addition | | | | 6.60, 6.72 |
| 1.8% WPC80 | 15 | 1.8 | 1.6:1 | 6.25, 6.36, 6.47, |
| Addition | | | | 6.59, 6.7 |

Gel Strength of the Acid Gel Samples from 15% Milk Samples Fortified with 0 to 1.8% WPC80

There is an interaction between heat treatment pH and WPC80 addition. At low levels of WPC80 addition (<0.45% WPC80 or >2.9:1 casein: whey ratio), higher heat treatment pHs give the highest acid gel strength. However, at WPC80 addition levels above 0.45% (casein: whey protein ratio below 2.9) this effect reverses, with increasingly lower pH giving higher acid gel strength. FIG. 4 summarises the effect of heat treatment pH and WPC80 addition on the final acid gel strength.

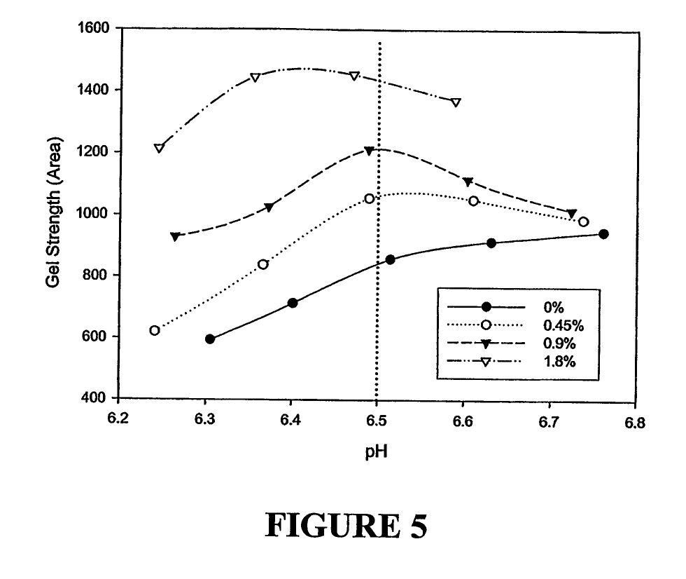

As the casein: whey protein ratio is decreased below 2.9, the optimum heat treatment pH steadily decreases. The optimum pH for maximum gel strength was determined as illustrated in FIG. 5 and showed that the optimum pH decreased with increasing WPC80 addition. FIG. 4 summarises the effect WPC80 addition level on the optimum heat treatment pH for both 10 and 15% skim milk powder samples. The gel strength of the acid gels can be varied depending on the pH at heating and the casein: whey protein weight ratio after addition of whey protein.

The above describes some preferred embodiments of the present invention and indicates several possible modifications but it will be appreciated by those skilled in the art that other modifications can be made without departing from the scope of the invention. This is defined in the appended claims.

### REFERENCES

Lucey J & Singh H (1998) Formation and physical properties of acid milk gels: a review. Food Research International, 30, 529-542

Bikker, J. F., Anema, S. G., Li, Y., & Hill, J. P., International Dairy Journal, 10, 723-732, (2000).

Ferry, J. D. (Ed.), Viscoelastic Properties of Polymers, 3rd edn. New York: John Wiley & Sons.

1. A process for preparing a yoghurt comprising the following steps:
a) adding a measured amount of whey protein to a milk and calculating the casein: whey protein weight ratio in the resulting mixture;
b) determining the optimum pH of the milk at the casein: whey protein ratio calculated in step a) for preparing a yoghurt having a desired gel strength;
c) adjusting the pH of the milk from step a) to the optimum pH, determined in step b),
d) heating the milk from step c) to a temperature of from 70° C. to its boiling point for a time of 0.1 seconds to 60 minutes, and
e) acidifying the milk stream from step d) using a microorganism treatment or chemical acidification to prepare a yoghurt.

2. The process of claim 1, wherein the casein: whey protein weight ratio calculated in step a) is from 3.2:1 to 1.6:1 and the optimum pH determined in step b) is from 7.1 to 6.5.

3. The process of claim 1, wherein the casein: whey protein weight ratio calculated in step a) is from 2.9:1 to 1.6:1 and the optimum pH determined in step b) is from 6.5 to 6.4.

4. The process of claim 1, wherein the temperature in step d) is maintained for from 10 seconds to 30 minutes.

5. The process of claim 1, wherein in step c) the pH is adjusted by the addition of either a food grade acid or base.

6. The process of claim 1 wherein, when required when the pH of the milk is above 6.7 at the end of the step d), the pH is lowered to 6.7 prior to step e).

7. The process of claim 1 wherein step e) is conducted at a temperature at or below about 30° C.

8. The process of claim 1, wherein in step e) glucono-delta-lactone is hydrolysed to acidify the milk.

9. (canceled)

10. The process of claim 2, wherein the temperature in step d) is maintained for from 10 seconds to 30 minutes.

11. The process of claim 2, wherein in step c) the pH is adjusted by the addition of either a food grade acid or base.

12. The process of claim 2, wherein when the pH of the milk is above 6.7 at the end of step d), the pH is lowered to 6.7 prior to step e).

13. The process of claim 2, wherein step e) is conducted at a temperature at or below about 30° C.

14. The process of claim 2, wherein in step e) glucono-delta-lactone is hydrolysed to acidify the milk.

15. The process of claim 3, wherein the temperature in step d) is maintained for from 10 seconds to 30 minutes.

16. The process of claim 3, wherein in step c) the pH is adjusted by the addition of either a food grade acid or base.

17. The process of claim 3 wherein step e) is conducted at a temperature at or below about 30° C.

18. The process of claim 3, wherein in step e) glucono-delta-lactone is hydrolysed to acidify the milk.
